(19) United States
(12) Patent Application Publication
(10) Pub. No.: US 2023/0343218 A1
(43) Pub. Date: Oct. 26, 2023

(54) BLIND SPOT DETECTING AND WARNING DEVICE SUITABLE FOR TWO-WHEELED MOBILE DEVICE

(71) Applicant: TRIOFORCE INTERNATIONAL INC., New Taipei City (TW)

(72) Inventors: FENG-CHENG CHEN, New Taipei City (TW); CHENG-HSIUNG LU, New Taipei City (TW); CHIA-SHENG SUNG, New Taipei City (TW); CHAO-HUANG CHEN, New Taipei City (TW); TZU-YU LIN, New Taipei City (TW); YI-CHIEH CHANG, New Taipei City (TW)

(21) Appl. No.: 17/728,593

(22) Filed: Apr. 25, 2022

(51) Int. Cl. G08G 1/16

(52) U.S. Cl. CPC G08G 1/167

(57) ABSTRACT

A blind spot detecting and warning device suitable for two-wheeled mobile device comprises a detecting device installed at a first position behind a user and a warning device installed at a second position that is in front of the user and can be seen by the user. The detecting device is provided with a sensing module, a control circuit and a signal transmitting module. When the sensing module senses a vehicle is approaching around, the sensing module generates a detection signal. The signal transmitting module receives the detection signal through the control circuit and then transmits the detection signal. The warning device is provided with a signal processing module and a warning module, wherein the signal processing module is used for receiving the detection signal transmitted by the signal transmitting module, and the detection signal drives the warning module to generate a warning.

### FIELD OF THE INVENTION

The present invention is related to a blind spot detecting and warning device suitable for two-wheeled mobile device, which is simple in structure, easy to assemble and low in cost, and the safety of riding can be improved, especially suitable for installation on various two-wheeled mobile devices such as human-powered bicycles, electric bicycles, motorbike or electric scooters.

### BACKGROUND OF THE INVENTION

Since bicycles or motorbikes are convenient to shuttle between streets and have mobility, with the rise of international oil prices, bicycles or motorbikes that are fuel-saving, environmentally friendly, energy-saving and carbon-reducing have always been popular goods. In addition, with the change of lifestyle, people pay more and more attention to the quality of leisure life. The natural environment such as countryside and suburbs has become people's new favorite. Bicycles and electric scooters are also very common as leisure vehicles.

However, in the existing bicycle design, due to the limitation of the speed of riding, there is no such a car-like design, such as rear-view mirrors, left and right rear-view mirrors, or blind spot detection for detecting vehicles located in the blind spot area. Therefore, during riding, there is no mechanism to generate a warning when a vehicle is approaching from behind. Although there are rear mirrors on both sides of the handlebar in the design of electric scooters or general fuel motorbikes, the rear view range and angle are very limited. Even when the rider judges that the rear object is approaching through the rear mirrors, it cannot fully reflect the actual approaching distance of the rear object. Hence, it often causes the rider to be too late to react, resulting in the danger of a collision. Therefore it needs to be improved.

### SUMMARY OF THE INVENTION

Therefore, in order to solve the existing problems of how to provide a car-like warning effect when a vehicle approaches from behind has always been the research direction of the inventor.

The main object of the present invention is to provide a blind spot detecting and warning device suitable for two-wheeled mobile device, which is simple in structure, easy to assemble and low in cost, and the safety of riding can be improved, especially suitable for installation on human-powered bicycles, electric bicycle, motorbike or electric scooters.

In order to achieve the above object, the present invention provides a blind spot detecting and warning device suitable for two-wheeled mobile device, which is used for warning a user that a vehicle is approaching from behind when the user is riding a bicycle or a motorbike. The blind spot detecting and warning device comprises a detecting device and a warning device. The detecting device is installed at a first position behind the user. The detecting device is provided with at least a sensing module, a control circuit, and a signal transmitting module. When the sensing module senses a vehicle approaching around, the sensing module generates a detection signal. The signal transmitting module receives the detection signal through the control circuit and then transmits the detection signal. The warning device is installed at a second position that is in front of the user and can be seen by the user. The warning device is provided with at least a signal processing module and a warning module, wherein the signal processing module is used for receiving the detection signal transmitted by the signal transmitting module, and the detection signal drives the warning module to generate a warning.

In implementation, the detecting device and the warning device are connected to a power supply module, respectively.

In implementation, the first position behind the user is an appropriate position behind the bicycle or the motorbike that the user rides, while the second position that is in front of the user and can be seen by the user is any appropriate position on handlebars of the bicycle or the motorbike.

In implementation, the first position behind the user is an appropriate position behind the bicycle or the motorbike that the user rides, while the second position that is in front of the user and can be seen by the user is an appropriate position on a helmet that the user wears.

In implementation, the warning module is a visual signal module or an auditory signal module.

For further understanding the characteristics and effects of the present invention, some preferred embodiments referred to drawings are in detail described as follows.

### BRIEF DESCRIPTION OF DRAWINGS

FIG. 1 is a schematic diagram of the appearance of an embodiment of the present invention after being assembled on a mobile body.

FIG. 2 is an architectural diagram of an embodiment of the present invention.

FIG. 3 is a schematic diagram of the appearance of an embodiment of the present invention with the warning module installed on the helmet.

### DETAILED DESCRIPTIONS OF PREFERRED EMBODIMENTS

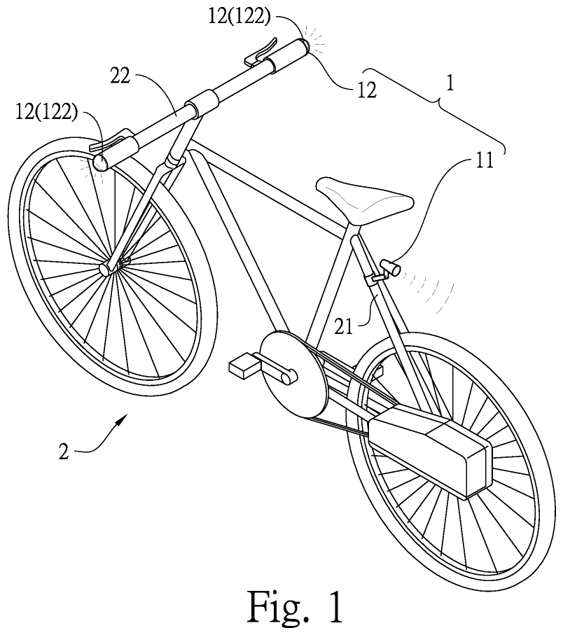

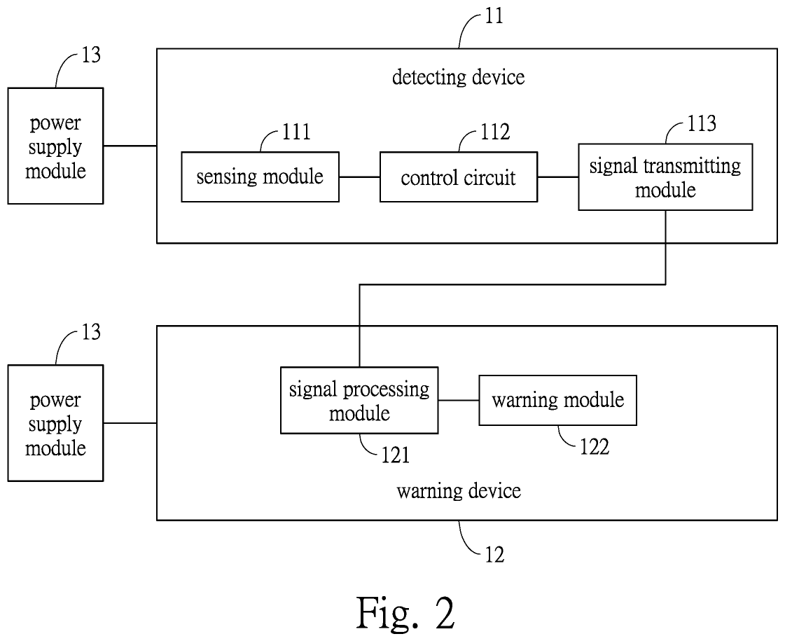

Please refer to FIGS. 1-2, which show an embodiment of a blind spot detecting and warning device 1 suitable for two-wheeled mobile device of the present invention. Taking an example that the blind spot detecting and warning device 1 is installed on a bicycle 2, the blind spot detecting and warning device 1 is used for warning a user that a vehicle is approaching from behind when the user rides the bicycle 2. A blind spot detecting and warning device 1 suitable for two-wheeled mobile device provided in the present invention comprises a detecting device 11 and a warning device 12.

The detecting device 11 is installed at a first position 21 behind the bicycle 2 that the user rides. The detecting device 11 is provided with at least a sensing module 111, a control circuit 112, and a signal transmitting module 113. When the sensing module 111 senses a vehicle approaching around, the sensing module 111 generates a detection signal. The signal transmitting module 113 receives the detection signal through the control circuit 112 and then transmits the detection signal.

The warning device 12 is a visual signal module or an auditory signal module. The warning device 12 is installed at a second position 22 that is in front of the user and can be seen by the user. The warning device 12 is provided with at least a signal processing module 121 and a warning module 122, wherein the signal processing module 121 is used for receiving the detection signal transmitted by the signal transmitting module 113, and the detection signal drives the warning module 122 to generate a warning.

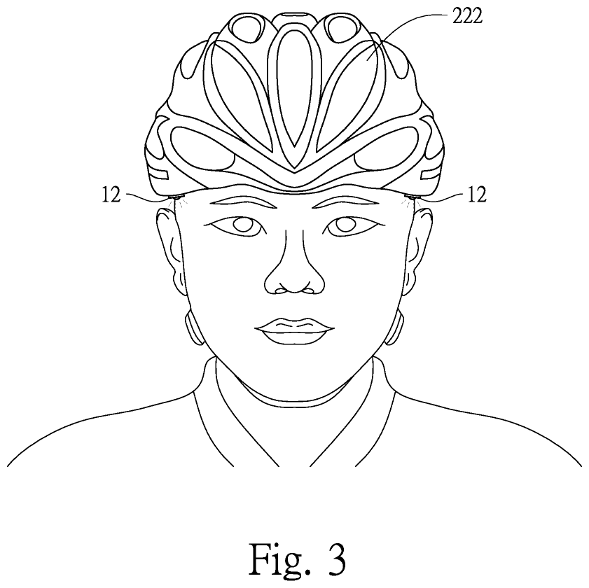

In implementation, the detecting device 11 and the warning device 12 are connected to a power supply module 13, respectively. The power supply module 13 may be a battery module or a circuit device connected to a mobile power supply. The first position 21 behind the user is an appropriate position behind the bicycle 2 or the motorbike that the user rides, such as the position under the seat cushion, on the shelf behind the mobile body, on the license plate or other convenient position, and the detecting device 11 can sense toward the rear of the mobile body without being shielded. The second position 22 that is in front of the user and can be seen by the user may be any appropriate position on the handlebars 221 of the bicycle 2 or the motorbike, such as shown in FIG. 1, the warning device 12 is installed at both ends of the handlebars 221. Or the warning device 12 can be installed at an appropriate position on a helmet 222 that the user wears (as shown in FIG. 3). The warning device 12 can be seen by the rider, so that the rider can receive the warning signal generated from the positions including the handlebars area and the helmet.

Hence, taking an example that the warning device 12 is installed on the handlebars 221 of the bicycle 2, when the detecting device 11 installed under the seat cushion of the bicycle 2 is activated, the detecting device 11 can sense the object approaching from behind (such as a vehicle approaching from behind). When the detecting device 11 senses a vehicle approaching from behind, a detection signal is generated and then transmitted to the warning device 12 to drive the warning module(s) 122 to generate a warning, so that the rider can directly see or hear the warning generated by the warning device 12, such as a light warning or a sound warning.

In addition, in the design, circuit design or direction identification can also be used, so that the rider can directly know the direction of the vehicle approaching from behind through a directional warning generated by the warning device 12.

Thereby, the design of the present invention has following advantages:
1. In present invention, the detecting device is installed behind the mobile body and the warning device is installed at the position that can be seen by the rider, so as to achieve the object of detecting the vehicle approaching from behind and generating a warning, especially when applied to human-powered bicycles, electric bicycles, motorbike or electric scooters, the safety of riding can be improved.
2. The design of the present invention is simple in structure, low in cost and easy to assemble, and can be achieved without changing the existing mobile body, which is suitable for installation on various kinds of human-powered bicycles, electric bicycles, motorbike or electric scooters.

As disclosed in the above description and attached drawings, the present invention can provide a blind spot detecting and warning device suitable for two-wheeled mobile device. It is new and can be put into industrial use.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

What is claimed is:

1. A blind spot detecting and warning device suitable for two-wheeled mobile device, which is used for warning a user that a vehicle is approaching from behind when said user is riding a bicycle or a motorbike, said blind spot detecting and warning device comprises:
a detecting device installed at a first position behind said user, and said detecting device being provided with at least a sensing module, a control circuit, and a signal transmitting module, wherein when said sensing module senses a vehicle approaching around, said sensing module generates a detection signal, and said signal transmitting module receives said detection signal through said control circuit and then transmits said detection signal; and
a warning device installed at a second position that is in front of said user and can be seen by said user, and said warning device being provided with at least a signal processing module and a warning module, wherein said signal processing module is used for receiving said detection signal transmitted by said signal transmitting module, and said detection signal drives said warning module to generate a warning.

2. The blind spot detecting and warning device suitable for two-wheeled mobile device according to claim 1, wherein said detecting device and said warning device are connected to a power supply module, respectively.

3. The blind spot detecting and warning device suitable for two-wheeled mobile device according to claim 1, wherein said first position behind said user is an appropriate position behind said bicycle or said motorbike that said user rides, while said second position that is in front of said user and can be seen by said user is any appropriate position on handlebars of said bicycle or said motorbike.

4. The blind spot detecting and warning device suitable for two-wheeled mobile device according to claim 1, wherein said first position behind said user is an appropriate position behind said bicycle or said motorbike that said user rides, while said second position that is in front of said user and can be seen by said user is an appropriate position on a helmet that said user wears.

5. The blind spot detecting and warning device suitable for two-wheeled mobile device according to claim 1, wherein said warning module is a visual signal module or an auditory signal module.

6. The blind spot detecting and warning device suitable for two-wheeled mobile device according to claim 5, wherein said detection signal generated by said sensing module has an identifiable direction, so that after said signal processing module receives and processes said detection signal, said warning module is driven to generate a directional warning.

7. The blind spot detecting and warning device suitable for two-wheeled mobile device according to claim 1, wherein said detection signal generated by said sensing module has an identifiable direction, so that after said signal processing module receives and processes said detection signal, said warning module is driven to generate a directional warning.
